(19) United States
(12) Patent Application Publication
(10) Pub. No.: US 2026/0358820 A1
(43) Pub. Date: Nov. 12, 2026

(54) ROBOT MOVEMENT CONTROL METHOD AND CONTROL SERVER FOR IMPLEMENTING SAME

(71) Applicant: LG ELECTRONICS INC., Seoul (KR)

(72) Inventors: Sungkyu KANG, Seoul (KR); Youngjae KIM, Seoul (KR)

(73) Assignee: LG ELECTRONICS INC., Seoul (KR)

(21) Appl. No.: 19/121,718

(22) PCT Filed: Dec. 12, 2022
(86) PCT No.: PCT/KR2022/020100

§ 371 Date: Apr. 16, 2025

(30) Foreign Application Priority Data
Nov. 10, 2022 (KR) 10-2022-0149482

(51) Int. Cl. G05D 1/644; G05D 1/69; G05D 1/85; G05D 107/70

(52) U.S. Cl. CPC G05D 1/644; G05D 1/69; G05D 1/852; G05D 2107/70

(57) ABSTRACT

The present disclosure relates to a robot movement control method and a control server for implementing same, the method enabling a plurality of robots to quickly arrive at a target position in an appropriate order without interrupting the movement of the other robots when the plurality of robots should move to the same target position. Provided is the robot movement control method and the like, the method comprising the steps of: calculating a final destination movement cost of each of a plurality of robots having the same final destination; and, if the plurality of robots do not have a previous destination movement cost or has a previous destination movement cost that exceeds a predetermined movement cost, assigning, to the plurality of robots in order from the robot with the lowest final destination movement cost, as current destinations, the final destination and one or more low priority destinations for same in order from the most significant destination.

### TECHNICAL FIELD

The present disclosure relates to a robot movement control method for moving a robot to an objective location and a control server implementing the same.

### BACKGROUND

The robot has been developed for industry and has been responsible for a part of factory automation. Recently, a robot-applied field has been further enlarged, so that a medical robot, an aerospace robot, and the like are developed, and a home robot that can be used in a general home is also being made. Among these robots, there is a robot capable of self-driving.

A plurality of robots may receive a movement command to the same objective location, plan a movement path to the objective location, and move to the objective location along the respective planned movement paths. In this case, when one of the plurality of robots arrives at the objective location first, at least one other robot needs to wait near the objective location until the one robot leaves the objective location. Other robots waiting near the objective location may impede movement of other robots. Therefore, the other robots need to wait in an appropriate location not to interfere with movement of the other robots.

### DISCLOSURE

### Technical Problem

The present disclosure is to provide a robot movement control method and a control server implementing the method, which enables a plurality of robots to quickly reach an objective location in an appropriate order without impeding movement of other robots when the plurality of robots need to move to the same objective location.

### Technical Solution

The present disclosure is to provide a robot movement control method including calculating a cost to go to a final goal of each of plurality of robots having the same final goal, and based on that the plurality of robots have no cost to a previous goal or a cost to a previous goal exceeding a predetermined travel cost, assigning, in order from a robot having a smallest cost to a final goal from among the plurality of robots, the final goal and at least one next priority goal for the final goal as a current goal in order from a highest goal.

The robot movement control method may further include, based on that at least one of the plurality of robots has a previous goal cost less than or equal to the predetermined travel cost, pre-occupying a corresponding previous goal and assigning the previous goal to the at least one robot as the current goal, and assigning, to remaining robots from among the plurality of robots, in order from a robot with a smallest cost to a final goal, at least one unoccupied goal from among the final goal and the next priority goal as the current goal in order from a highest priority goal.

The robot movement control method may further include generating a global path passing through a corresponding current goal for each robot of the plurality of robots, and providing the generated global path to each robot The final goal and the at least one next priority goal may be pre-designated goals.

Based on that a first robot is located in the final goal, the next priority goal may be a goal for a second robot to wait until a first robot leaves the final goal.

Even if the second robot waits at the next priority goal, a location of the next priority goal may be determined to minimize movement impediment of a first robot or a third robot.

The next priority goal may include a waiting goal for the final goal and at least one temporary goal for the waiting goal.

The global path may be to be generated to further pass through at least one of a pass-through goal or a traffic goal.

Assignment of the current goal may be performed based on that a mission scheduled to move toward the final goal is assigned to one robot.

Assignment of the current goal may be performed based on that one robot of the plurality of robots leaves the final goal.

The present disclosure is to provide a control server for controlling movement of a robot, the control server including a warehouse management system (WMS) configured to manage at least one item and an order for a location of the item, a material control system (MSC) configured to configure at least one order as a mission, a mission scheduler configured to schedule a route for the mission, and a fleet management system (FMS) configured to generate a global path of a robot for the route-scheduled mission, wherein the FMS is configured to calculate the cost to a final goal of each of a plurality of robots having the same final goal, and based on that the plurality of robots have no cost to a previous goal or a cost to a previous goal exceeding a predetermined travel cost, assign, in order from a robot having a smallest cost to a final goal from among the plurality of robots, the final goal and at least one next priority goal for the final goal as a current goal in order from a highest goal.

### Advantageous Effects

Effects of the robot movement control method and a control server implementing the same according to the present disclosure are described as follows.

According to at least one of the embodiments of the present disclosure, when a plurality of robots need to move to the same objective location, there is an advantage in that the robots may quickly reach the objective location in an appropriate order without impeding movement of other robots.

### BRIEF DESCRIPTION OF THE DRAWINGS

FIG. 1 is a block diagram illustrating components constituting a robot according to an embodiment of the present disclosure.

FIG. 2 is a flowchart for performing robot movement according to an embodiment of the present disclosure.

FIG. 3 shows an example of an operation area of a robot according to an embodiment of the present disclosure.

FIG. 4 is a flowchart of generating a partial trajectory passing through a narrow section according to an embodiment of the present disclosure.

FIG. 4 illustrates the configuration of a control server according to an embodiment of the present disclosure.

FIG. 5 is a configuration and operation flowchart of an FMS in a control server according to an embodiment of the present disclosure.

FIGS. 6 and 11 are enlarged views of a portion of the operation area of FIG. 3.

FIG. 12 illustrates goal assignment for each robot according to an embodiment of the present disclosure.

FIG. 13 is a table for robot goal assignment of FIG. 12.

FIG. 14 illustrates goal assignment for each robot according to an embodiment of the present disclosure.

FIG. 15 is a table for robot goal assignment of FIG. 14.

FIG. 16 illustrates goal assignment for each robot according to an embodiment of the present disclosure.

FIG. 17 is a table for robot goal assignment of FIG. 16.

FIG. 18 illustrates goal assignment for each robot according to an embodiment of the present disclosure.

FIG. 19 is a table for robot goal assignment of FIG. 18.

FIG. 20 is a flowchart showing a control server assigning a goal to each robot according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Each of these elements may be configured as a separate individual hardware module or implemented as two or more hardware modules. Two or more elements may be implemented as a single hardware module. In some cases, at least one of these elements may be implemented as software.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

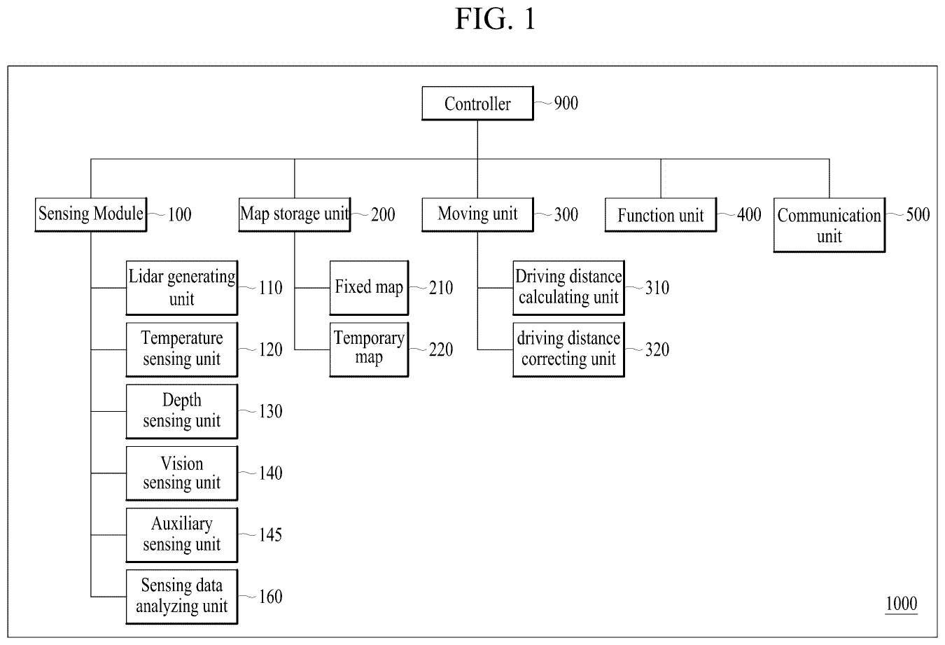

Components constituting a robot according to an embodiment of the present disclosure will be described with reference to FIG. 1. FIG. 1 is a block diagram illustrating components constituting a robot according to an embodiment of the present disclosure.

A robot 1000 may include a sensing module 100 for sensing a moving object or a fixed object disposed outside, a map storage unit 200 for storing various types of maps, a moving unit 300 for controlling the movement of the robot, a function unit 400 for performing a prescribed function of the robot, a communication unit 500 for transmitting and receiving information about a map or a moving object, a fixed object, or an external changing situation with another robot or a server, and a controller 900 for controlling each of these components.

FIG. 1 hierarchically configures the components of a robot, which shows the components of the robot logically. A physical configuration thereof may be different. That is, a multitude of logical components may be included in one physical component, or a plurality of physical components may implement one logical component.

The sensing module 100 senses external objects such as an obstacle and provides sensed information to the controller 900. According to an embodiment, the sensing module 100 may include a lidar sensing unit 110 that calculates a material and a distance of external objects such as a wall, glass, a metallic door and the like at a current position of the robot as an intensity and reflected time (speed) of a signal. In addition, the sensing module 100 may include a temperature sensing unit 120 that calculates temperature information of objects disposed within a predetermined distance from the robot 1000. An embodiment of the temperature sensing unit 120 includes an infrared sensor that senses a temperature of a thing disposed within a predetermined distance from the robot 1000, particularly, body temperatures of people. When the temperature sensing unit 120 is configured with an infrared array sensor, a temperature of an object may be sensed without contact. When the infrared sensor or the infrared array sensor configures the temperature sensing unit 120, main information for checking whether a moving object is a person may be provided.

In addition, the sensing module 100 may further include a depth sensing unit 130 that calculates depth information between the robot and an external object and a vision sensing unit 140 in addition to the sensing units described above.

The depth sensing unit 130 may include a depth camera. The depth sensing unit 130 may determine a distance between the robot and the external object, and in particular, may be coupled to the lidar sensing unit 110 to increase the sensing accuracy of the distance between the external object and the robot.

The vision sensing unit 140 may include a camera. The vision sensing unit 140 may capture images of objects around the robot. In particular, the robot may identify whether an external object is a moving object by distinguishing between an image in which there is no change like a fixed object and an image in which a moving object is disposed.

In addition, a multitude of auxiliary sensing units 145 such as a heat sensing unit, a ultrasonic sensing unit, and the like may be disposed. These auxiliary sensing units provide auxiliary sensing information necessary to generate a map or sense an external object. In addition, the auxiliary sensing units also provide information by sensing an object disposed outside when the robot travels.

The sensing data analyzing unit 150 analyzes the information sensed by a multitude of the sensing units and transmits the analyzed information to the controller 900. For example, when an object disposed outside is sensed by a multitude of the sensing units, each of the sensing units may provide information about the characteristics and distance of the corresponding object. The sensing data analyzing unit 150 may perform calculation by combining values of the informations and transmit the calculation result to the controller 900.

The map storage unit 200 stores information of objects disposed in a space in which the robot moves. The map storage unit 200 may include a fixed map 210 that stores information about fixed objects, which have no variation or are disposed in a manner of being fixed, among objects disposed in an entire space in which the robot moves. A single fixed map 210 may be essentially included depending on a space. Since only objects having the lowest change in the corresponding space are disposed in the fixed map 210, it may sense more objects than objects than those indicated by the map 210 when the robot moves in the corresponding space.

The fixed map 210 essentially stores position information of the fixed objects, and may additionally include characteristics of the fixed objects, for example, material information, color information, other height information, etc. When a variation item occurs in the fixed objects, these additional informations facilitate the robot to check the variation item.

In addition, the robot may generate a temporary map 220 by sensing the surroundings in the process of moving, and compare the temporary map 220 with the fixed map 210 for the entire space stored in the past. As a result of the comparison, the robot may confirm a current position.

The moving unit 300 is a means for moving the robot 1000, such as a wheel, and moves the robot 1000 under the control of the controller 900. In doing so, the controller 900 may check a current position of the robot 1000 in the area stored in the map storage unit 200 and provide a moving signal to the moving unit 300. The controller 900 may generate a path in real time or generate a path in a movement process by using various informations stored in the map storage unit 200.

The moving unit 300 may include a driving distance calculating unit 310 and a driving distance correcting unit 320. The driving distance calculating unit 310 may provide information on the distance traveled by the moving unit 300. According to an embodiment, the accumulated distance moved by the robot 1000 starting at a specific point may be provided. Alternatively, an accumulated distance for the robot 1000 to move linearly after rotating at a specific point may be provided. Alternatively, an accumulated distance for the robot 100 to move from a specific timing point may be provided.

In addition, according to an embodiment of the present disclosure, the driving distance calculating unit 310 may provide information on a moving distance within a predetermined unit as well as an accumulated distance. The driving distance calculating unit 310 may calculate various distances according to the characteristics of the moving unit 300. When the moving unit 300 is a wheel, the driving distance calculating unit 310 may calculate a driving distance by counting the number of rotations of the wheel.

When the distance calculated by the driving distance calculating unit 310 is different from the distance information actually calculated by the sensing module 100 of the robot 1000, the driving distance correcting unit 320 corrects the distance information calculated by the driving distance calculating unit 310. In addition, when an error occurs in a manner of being accumulated in the driving distance calculating unit 310, the controller 900 or the moving unit 300 may be informed to change the driving distance calculation logic of the driving distance calculating unit 310.

The function unit 400 means to provide a specialized function of the robot. For example, in case of a cleaning robot, the function unit 400 includes components required for cleaning. In case of a guidance robot, the function unit 400 includes components required for guidance. In case of a security robot, the function unit 400 includes components required for security. The function unit 400 may include various components according to functions provided by the robot, by which the present disclosure is non-limited.

The controller 900 of the robot 1000 may generate or update a map of the map storage unit 200. In addition, the controller 900 may identify whether an object is a moving object or a fixed object by identifying information of the object provided by the sensing module 100 during a driving process, thereby controlling the driving of the robot 1000.

In summary, when the sensing module 100 senses an object disposed outside, the controller 900 of the robot 1000 may identify a moving object among objects sensed based on the characteristic information of the sensed objects, thereby setting a current position of the robot based on the information sensed by the sensing module as a fixed object except the moving object.

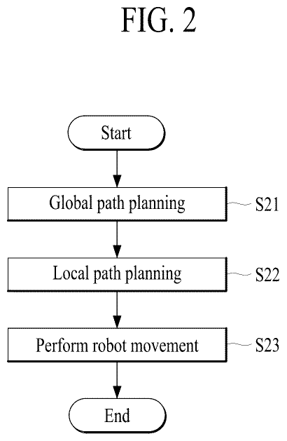

Hereinafter, with reference to FIG. 2, robot movement performance according to an embodiment of the present disclosure will be described. FIG. 2 is a flowchart for performing robot movement according to an embodiment of the present disclosure.

Global path planning may be established for a robot 1000 to move to an objective location. Here, the global path planning means planning a fastest path from a starting location to the objective location while avoiding collision with obstacles based on the obstacle map.

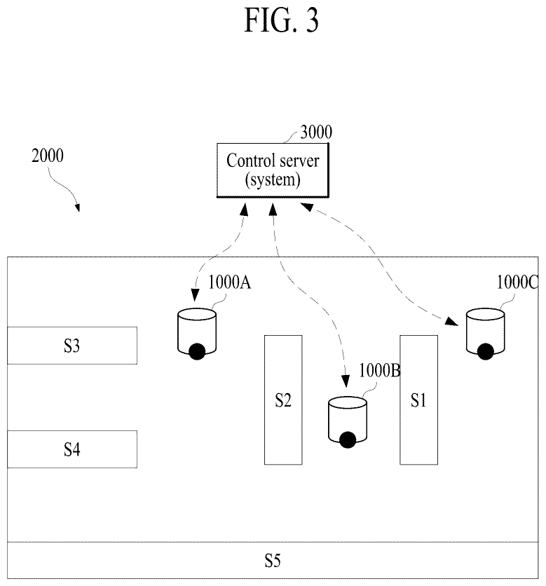

The global path planning may be established by a control server 3000 (in FIG. 3) and received by the robot 1000. Alternatively, the global path planning may be established by the robot 1000 based on information about the objective location received from the control server and map information of an operation area in which the robot 1000 operates. The map information may include an obstacle map indicating obstacles (and/or moveable space) within the operation area. The obstacle map may include information about a dynamic obstacle as well as a static obstacle.

Then, the robot 1000 (i.e., the controller 900) may establish local path planning [S22]. The local path planning locally regenerates a path by using sensor information sensed in real time by the sensor module 100 to avoid an obstacle or a moving obstacle that is not listed on the obstacle map when the robot 1000 moves along the global path.

Then, the robot 1000 may move to the objective location based on the global path planning and the local path planning through the moving unit 300 [S23].

FIG. 3 shows an example of an operation area of a robot according to an embodiment of the present disclosure.

An operation area 2000 (e.g., logistics warehouse) in which a plurality of robots 1000A, 1000B, and 1000C is capable of operating may include at least one shelf. In FIG. 3, a first robot 1000A, a second robot 1000B, and a third robot 1000C are illustrated as being operated in the operation area 2000, but fewer or more robots may be operated. Each of the plurality of robots may be the robot described with reference to FIG. 1.

The operation area 2000 may have a plurality of shelves S1, S2, S3, S4, and S5. In FIG. 3, five shelves in a rectangular shape (e.g., a loading platform for storing items), that is, a first shelf S1, a second shelf S2, a third shelf S3, a fourth shelf S4, and a fifth shelf S5, are illustrated as being within the operation area 2000, but fewer or more shelves and/or shelves of different shapes may be within the operation area 2000.

The plurality of robots 1000A, 1000B, and 1000C may, under control of a control server (or system) 3000, pick up items (e.g., product) loaded on one of the plurality of shelves and transport the items to another location (e.g., product packaging location).

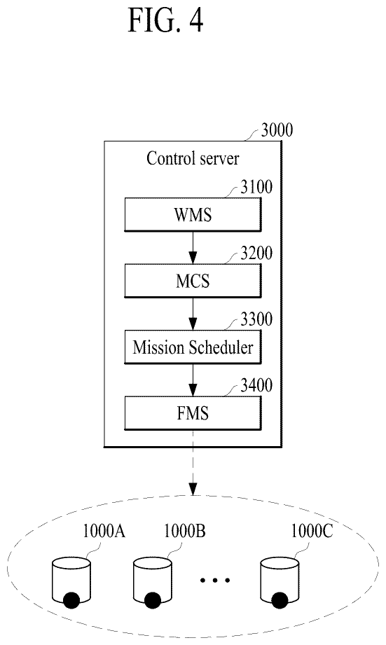

Hereinafter, with further reference to FIG. 4, the configuration of the control server 3000 will be described in more detail. FIG. 4 illustrates the configuration of a control server according to an embodiment of the present disclosure.

The control server 3000 may include a warehouse management system (WMS) 3100, a material control system (MCS) 3200, a mission scheduler 3300, and a fleet management system (FMS) 3400.

The WMS 3100 is a logistics system that may manage the locations of the loaded items and an order list for at least one item, which needs to be picked up and transported for packaging, from among the loaded items. An order may mean a list of at least one item ordered by a customer and a loading location for the at least one item. For example, a first list of at least one item ordered by a first customer and its location may be managed as a first order, and a second list of at least one item ordered by a second customer and its location may be managed as a second order. A plurality of orders including the first order and the second order may be managed as an order list.

The MCS 3200 may receive the order list from the WMS 3100 and generate a mission to pick up and transport the ordered item. The mission may include at least one order. For example, when loading locations of items in the first list and loading locations of items in the second list are similar to each other, the first order and the second order may be generated as one mission, and when loading locations of items in the first list and loading locations of the second list are not similar to each other, the first order and the second order may be generated as different missions.

The mission scheduler 3300 may receive the generated mission from the MCS 3200, schedule a route (or order) for picking up and transporting at least one item in the mission, and assign the route-scheduled mission to a robot.

The FMS 3400 may receive the route-scheduled mission from the mission scheduler 3300, generate a movement path, i.e., a global path, for each of the robots 1000A, 1000B, and 1000N to move according to the route-scheduled mission to perform the route-scheduled mission, and provides the path to each robot. When the global path is generated, the FMS 3400 may consider not only an obstacle within the operation area 2000 but also the locations of other robots.

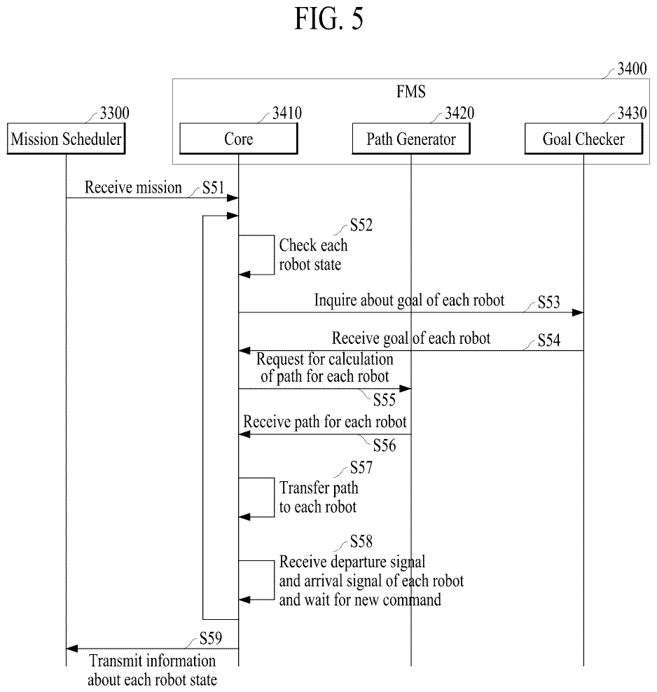

The configuration and operation of the FMS 3400 will be further described with reference to FIG. 5. FIG. 5 is a configuration and operation flowchart of an FMS in a control server according to an embodiment of the present disclosure.

The FMS 3400 may include a core 3410, a path generator 3420, and a goal checker 3430. These modules may include hardware or software.

The core 3410 may receive the route-scheduled mission from the mission scheduler 3300 [S51].

Then, the core 3410 may check a state of each robot operating within the operation area 2000 (e.g., state regarding whether a robot performs a mission, or whether the robot is driven) [S52].

The core 3410 may inquire about information about a goal of each robot to the goal checker 3430 and receive information about the goal of each robot from the goal checker 3430 [S53 and S54]. The core 3410 may inquire about information regarding goals of all robots operating within the operation area 2000 or may inquire about information regarding only the goals of robots that currently perform a mission.

The core 3410 may request the path generator 3420 to calculate a path for each robot (including a robot to perform the scheduled mission) that matches the scheduled mission based on information about the goal of each robot and may receive the calculated path for each robot from the path generator 3420 [S55 and S56]. Depending on the scheduling mission, the existing path of a robot other than the robot that will perform the scheduling mission may be changed. This will be explained again below. The path may be a global path for each robot.

The core 3410 may transfer the calculated path to each robot [S57]. Then, each of the robots may start driving according to the calculated path.

The core 3410 may receive a departure signal and a goal arrival signal from each robot and may also wait for a new command from the mission scheduler 3300 [S58].

The core 3410 may provide information about a state of each robot to the mission scheduler 3300 [S59]. The mission scheduler 3300 may schedule a mission based on information about the state of each robot.

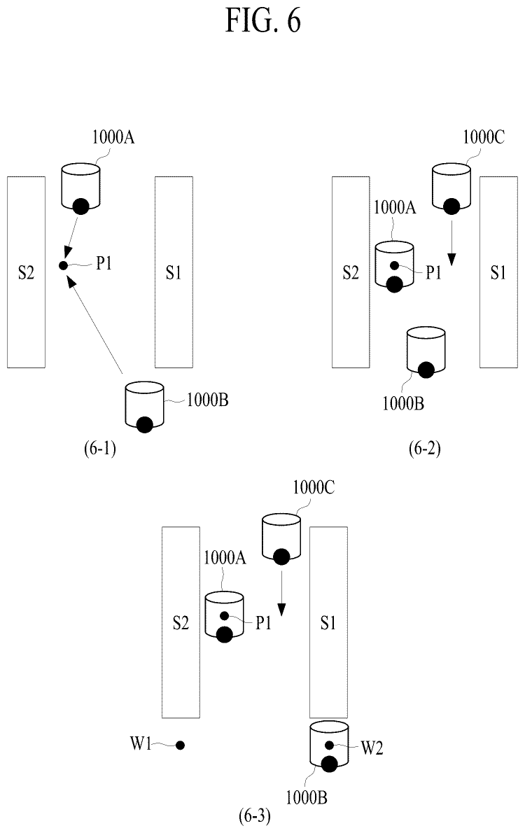

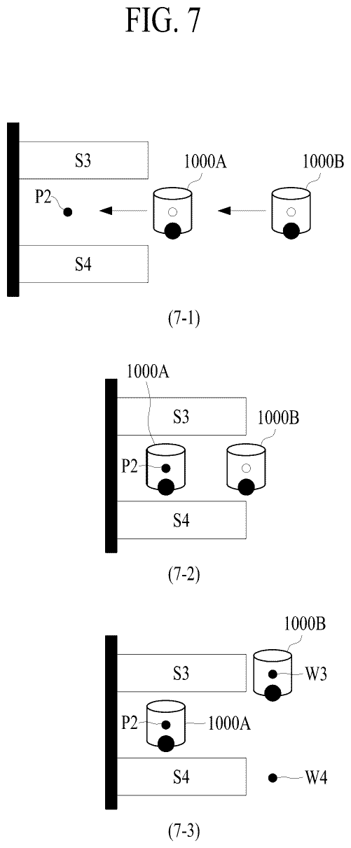

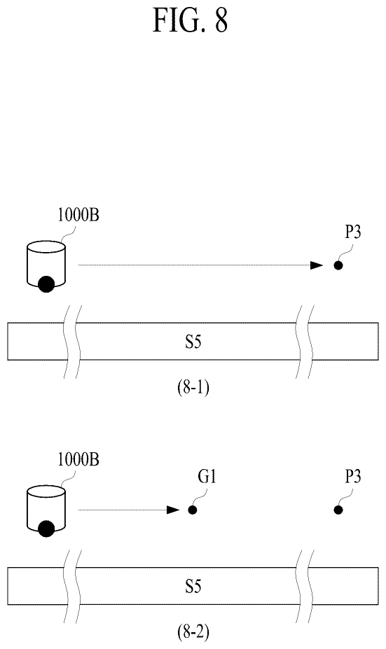

Hereinafter, a need to change the existing global path of each robot will be described with reference to FIGS. 6 and 7. A change in the existing global path of each robot may also be understood as a change in the goal of each robot. FIGS. 6 and 7 are enlarged views of a portion of the operation area of FIG. 3. FIG. 6 illustrates the first shelf S1 and the second shelf S2 within the operation area 2000, and FIG. 7 illustrates the third shelf S3 and the fourth shelf S4 within the operation area 2000.

First, this will be described with reference to FIG. 6.

As shown in (6-1) of FIG. 6, it is assumed that while a second robot 1000B currently moves to a goal P1 in a passage between the first shelf S1 and the second shelf S2 from afar along a global path of the second robot 1000B, a first robot 1000A, which is located closer to the goal Pl than the second robot 1000B, is ordered to move to the goal P1. The passage between the first shelf S1 and the second shelf S2 is an open passage through which a robot is capable of passing from one side to the other. Then, the first robot 1000A may reach the goal P1 faster and occupy the goal P1. It is assumed that the goal is a final goal (point of interest (POI)) for the first robot 1000A and the second robot 1000B to pick up items loaded on the second shelf S2. The final goal may also be referred to as a final goal.

In this case, as shown in (6-2) of FIG. 6, the first robot 1000A arrives at a final goal P1 faster and preoccupies the final goal P1, and thus when the second robot 1000B waits in the center of the passage in which the final goal P1 is located until the first robot 1000A leaves the final goal P1, this may impede movement of another third robot 1000C through the passage.

Therefore, as shown in (6-3) of FIG. 6, at least one intermediate goals W1 and W2 needs to be pre-determined as a waiting location for the final goal P1. The at least one intermediate goal may be determined to a location that does not interfere with or causes minimal interference with movement of other robots even if one robot waits there. Therefore, the intermediate goals W1 and W2 may also be referred to as “waiting goal”. In (6-3) of FIG. 6, there are a first intermediate goal W1 and a first intermediate goal W2 for the final goal P1, but there may be fewer or more intermediate goals. When the second robot 1000B waits at the second intermediate goal W2 that is closest to its existing global path or may move fastest away from its existing global path from among the first intermediate goal W1 and the second intermediate goal W2, this may not impede or may minimally impede the movement of the third robot 1000C. That is, the existing global path toward the final goal P1 of the second robot 1000B needs to be changed to include the second intermediate goal W2.

Hereinafter, this will be described with reference to FIG. 7.

As shown in (7-1) of FIG. 7, it is assumed that while the second robot 1000B currently moves to a final goal P2 in a passage between the third shelf S3 and the fourth shelf S4 from afar along a global path of the second robot 1000b, the first robot 1000A, which is located closer to the final goal P2 than the second robot 1000b, is ordered to move to the final goal P2. The passage between the third shelf S3 and the fourth shelf S4 is a closed passage (e.g., a dead-end alley) through which a robot is not capable of passing from one side to the other.

In this case, as shown in (7-2) of FIG. 7, the first robot 1000A arrives at the final goal P2 faster and preoccupies the final goal P2, and thus when the second robot 1000b waits in the center of the passage in which the final goal P2 is located until the first robot 1000A leaves the final goal P2, the first robot 1000A may not exit the passage due to the second robot 1000B. That is, the first robot 1000A and the second robot 1000B may fall into a deadlock.

Therefore, as shown in (7-3) of FIG. 7, at least one intermediate goals W3 and W4 needs to be pre-determined as a waiting location for the final goal P2. In (7-3) of FIG. 7, there are a third intermediate goal W3 and a fourth intermediate goal W4 for the final goal P2, but there may be fewer or more intermediate goals. When the second robot 1000B waits at the third intermediate goal W3 that is closest to its existing global path or may move fastest away from its existing global path from among the third intermediate goal W3 and the fourth intermediate goal W4, the first robot 1000A may exit the passage without being impeded by the second robot 1000B. That is, the existing global path toward the final goal P2 of the second robot 1000B needs to be changed to include the third intermediate goal W3.

When the robot has a long route to the final goal according to its mission and the entire global path for moving the entire long route is planned at once, it may take a lot of time to plan the entire global path. The planned entire global path may need to be modified due to other variables that may occur while the robot drives along the planned entire global path (e.g., pre-occupation of a final goal by another robot). When the entire global path is modified, a time and computational resources required to plan the entire global path may be wasted. Therefore, when a robot has a long route distance depending on its mission, the entire global path for movement of the entire long route distance may not be planned at once. That is, a partial global path may be planned only to a midpoint of the long route distance, and while the robot moves along the partial global path, the remaining global path from the midpoint to the final goal may be planned. This will be further described with reference to FIG. 8. FIG. 8 is an enlarged view of a portion of the operation area of FIG. 3. FIG. 8 illustrates the fifth shelf S5 within the operation area 2000.

As shown in (8-1) of FIG. 8, when a final goal P3 is relatively far from the current location of the second robot 1000B, Global path planning may be established for movement of the entire long route distance to the final goal P3. However, in this case, when the entire global path for movement of the entire long route distance is planned at once, it may take a lot of time to plan the entire global path. The planned entire global path may need to be modified due to other variables that may occur while the second robot 1000B drives along the planned entire global path (e.g., pre-occupation of the final goal P3 by the first robot 1000A). When the entire global path is modified, a time and computational resources required to plan the entire global path may be wasted. Therefore, when the second robot 1000B has a long route distance depending on its mission, the entire global path for movement of the entire long route distance may not be planned at once.

Therefore, as shown in (8-2) of FIG. 8, a partial global path may be planned for the second robot 1000B to move to an intermediate goal G1 between the current location and the final goal P3. While the second robot 1000B moves along the partial global path, a remaining global path may be planned to move from the intermediate goal G1 to the final goal P3. The second robot 1000B may move to the final goal P3 along the remaining global path when reaching the intermediate goal G1.

The intermediate goal may be specified as two or more between the current location and the final goal P3. For example, two intermediate goals, that is, a first intermediate goal and a second intermediate goal, may be specified between the current location and the final goal P3. While the second robot 1000B moves along the first partial global path from the current location to the first intermediate goal, a second partial global path may be planned for moving from the first intermediate goal to the second intermediate goal, and after the first intermediate goal is reached, while the second robot 1000B moves along the second partial global path, a remaining global path may be planned for moving from the second intermediate goal to the final goal P3, and after reaching the second intermediate goal, the second robot 1000B may move along the remaining global path. The intermediate goal G1 may also be referred to as a pass-through goal.

The robot may need to pass a crowded section, such as a three-way or four-way intersection in the operation area 2000. In this case, when the robot passes through the intersection without pause along its global path, this may cause a collision with another robot. Therefore, when the robot needs to pass through the crowded section, the robot may pause at a point immediately before the crowded section, check the surroundings, and then pass through the crowded section. This will be further described with reference to FIG. 9. FIG. 9 is an enlarged view of a portion of the operation area of FIG. 3. FIG. 9 illustrates the second shelf S2, the third shelf S3, and the fourth shelf S4 within the operation area 2000.

As shown in (9-1) of FIG. 9, when there is a three-way intersection between the current location of the second robot 1000B and a final goal P4, global path planning may be established from the current location to the final goal P4 passing through the three-way intersection. However, when the second robot 1000B enters the intersection without pause along the global path, there is a possibility that the second robot 1000B collides with another third robot 1000C that also enters the intersection.

Therefore, as shown in (9-2) of FIG. 9, an intermediate goal X1 for pause before entering a crowded section like the intersection is needed to be predetermined. That is, the existing global path toward the final goal P4 of the second robot 1000B needs to be changed to include the intermediate goal X1. Accordingly, if the second robot 1000B drives along the changed global path, when reaching the intermediate goal X, the second robot 1000B may pause and check, through a sensing module 100, whether there are any other objects at risk of collision in the crowded section, and then pass through the crowded section. The intermediate goal X1 may also be referred to as a traffic goal.

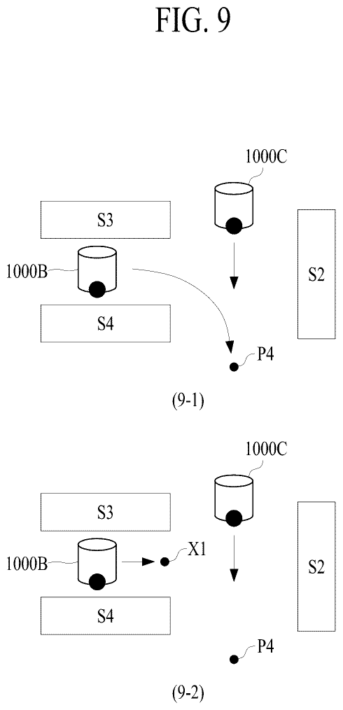

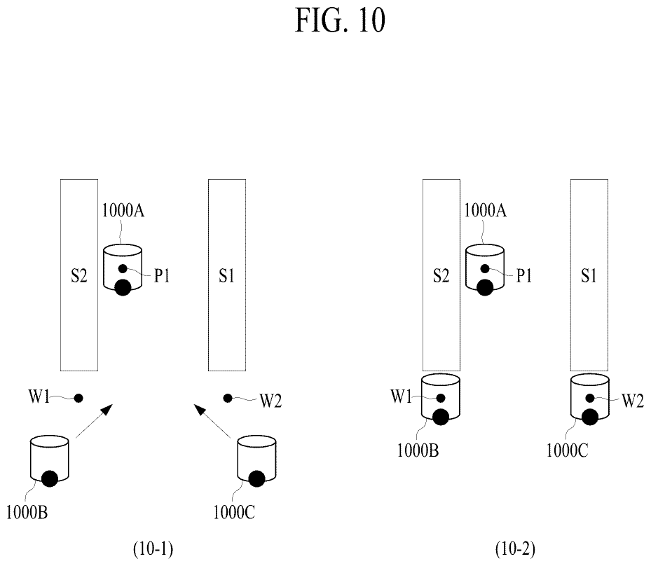

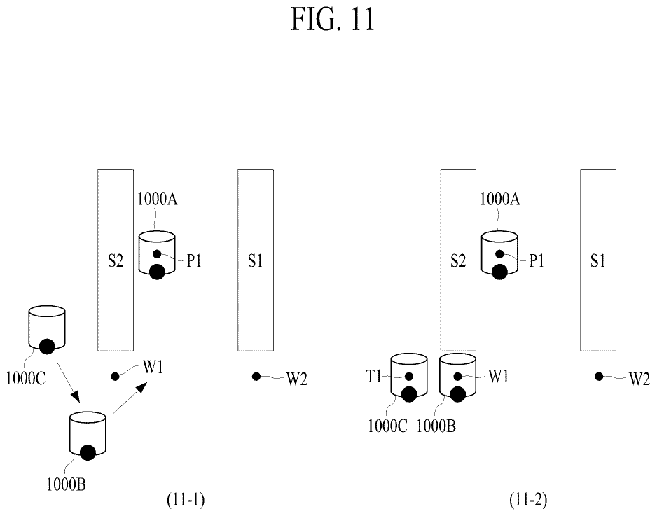

As described above, when the first robot 1000A pre-occupies the final goals Pl and P2, there may be a plurality of intermediate goals W1, W2, W3, and W4 at which the second robot 1000B is capable of waiting until the first robot 1000A leaves the final goal P1. This will be further described with reference to FIGS. 10 and 11. FIGS. 10 and 11 are enlarged views of a portion of the operation area of FIG. 3. FIGS. 10 and 11 illustrate the first shelf S1 and the second shelf S2 within the operation area 2000. In FIGS. 10 and 11, it is assumed that there are two intermediate goals for the final goal P1, that is, the first intermediate goal W1 and the second intermediate goal W2.

First, this will be described with reference to FIG. 10.

As shown in (10-1) of FIG. 10, it is assumed that the second robot 1000B and the third robot 1000C move to the final goal P1 from different directions while the first robot 1000A occupies the final goal P1. For example, the second robot 1000B may currently move toward the final goal P1 from a location closer to the first intermediate goal W1 than to the second intermediate goal W2, and the third robot 1000C may move toward the final goal Pl from a location closer to the second intermediate goal W2 than to the first intermediate goal W1.

Then, as shown in (10-2) of FIG. 10, until the first robot 1000A leaves the final goal P1, the second robot 1000B may wait at the first intermediate goal W1 closest to its global path, and the third robot 1000C may wait at the second intermediate goal W2 closest to its global path.

When the first robot 1000A leaves the final goal P1, the robot that arrives first at either the first intermediate goal W1 or the second intermediate goal W2 from among the second robot 1000B and the third robot 1000C may depart for the final goal P1 first, and the robot that arrives late may continue to wait.

When the robot that arrived first leaves the final goal P1, the robot that arrives late may depart for the final goal P1.

Hereinafter, this will be described with reference to FIG. 11.

As shown in (11-1) of FIG. 11, it is assumed that the second robot 1000B and the third robot 1000C move to the final goal P1 from the same or similar direction while the first robot 1000A occupies the final goal P1. For example, both the second robot 1000B and the third robot 1000C may move toward the final goal P1 from a location closer to the first intermediate goal W1 than to the second intermediate goal W2, and the second robot 1000B may move closer to the first intermediate goal W1 than the third robot 1000C. If driving like this, for example, the second robot 1000B and the third robot 1000C have the same driving speed, and thus the second robot 1000B may arrive at the first intermediate goal W1 before the third robot 1000C.

Then, as shown in (11-2) of FIG. 11, until the first robot 1000A leaves the final goal P1, the second robot 1000B may wait at the first intermediate goal W1 closest to its global path. Until the first robot 1000A leaves the final goal P1, the third robot 1000C may wait at a temporary goal T1 for the first intermediate goal W1.

When the first robot 1000A leaves the final goal P1, the second robot 1000B may depart for the final goal P1, and then the third robot 1000C may depart for the first intermediate goal W1.

When the second robot 1000B leaves the final goal P1, the third robot 1000c may depart for the final goal P1.

At least one temporary goal, for example, a first temporary goal T1, a second temporary goal T2, or a third temporary goal T3, may be predetermined for the first intermediate goal W1. These temporary goals may also be set to locations that do not impede or minimally impede movement of other robots. This may be applied to other intermediate goals W2, W3, and W4 in the same way.

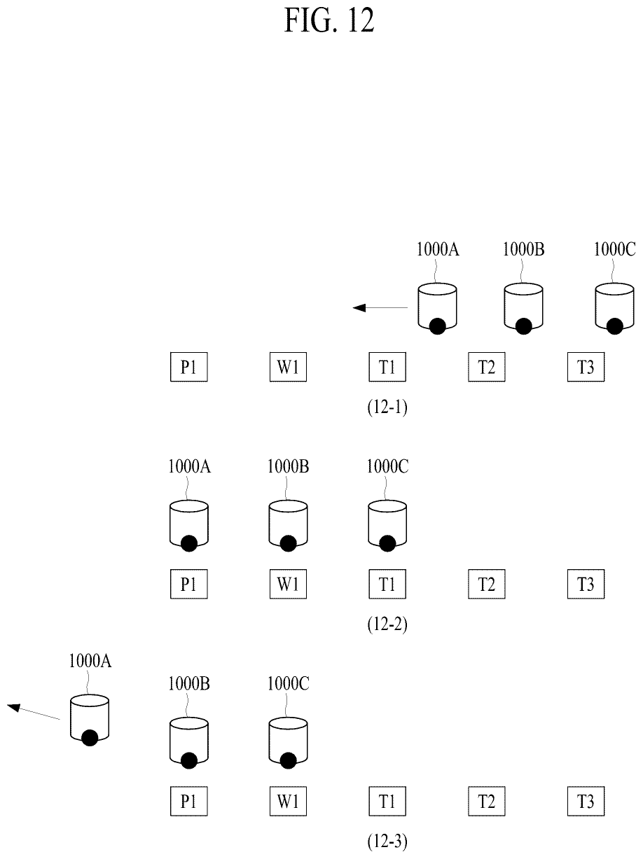

When a plurality of robots move simultaneously toward the final goal P1 in the same or similar direction as shown in (11-1) of FIG. 11, if a robot pre-occupies the final goal P1, the plurality of robots may wait at the first intermediate goal W1, the first temporary goal T1, the second temporary goal T2, the third temporary goal T3, and the like in the order in which the robots approach the final goal P1. In relation to establishment of global path planning considering the goals, this will be further described with reference to FIG. 12. FIG. 12 illustrates goal assignment for each robot according to an embodiment of the present disclosure.

As shown in (12-1) of FIG. 12, it is assumed that the first robot 1000A, the second robot 1000B, and the third robot 1000C need to all move to the final goal P1. Here, the current location of the first robot 1000A may be closest to the final goal P1, the current location of the third robot 1000C may be farthest from the final goal P1, and the current location of the second robot 1000B may be between the first robot 1000A and the third robot 1000C. When the first robot 1000A, the second robot 1000B, and the third robot 1000C have the same or similar driving speeds, the first robot 1000A, the second robot 1000B, and the third robot 1000C may sequentially reach the final goal P1.

Then, the control server 3000, i.e., the FMS 3400, may establish a first global path for the first robot 1000A such that the first robot 1000A moves directly to the final goal P1, establish a second global path for the second robot 1000B such that the second robot 1000B moves to the final goal P1 via the first intermediate goal W1, and establish a third global path for the third robot 1000C such that the third robot 1000C sequentially moves to the final goal P1 via the first temporary goal T1 and the first intermediate goal W1. That is, when arrival goals for the final goal P1 are assigned to the first robot 1000A, the second robot 1000B, and the third robot 1000C, respectively, the control server 3000 may assign the final goal P1, the first intermediate goal W1, and the first temporary goal T1 to the first robot 1000A, the second robot 1000B, and the third robot 1000C, respectively. The first global path, the second global path, and the third global path may be provided to the first robot 1000A, the second robot 1000B, and the third robot 1000C, respectively.

Then, as shown in (12-2) of FIG. 12, the first robot 1000A may move to the final goal P1 along the first global path, the second robot 1000B may move to the first intermediate goal W1, and the third robot 1000C may move to the first temporary goal T1.

As shown in (12-3) of FIG. 12, when the first robot 1000A leaves the final goal P1, the second robot 1000B may move to the final goal P1, and the third robot 1000C may move to the first intermediate goal W1.

Although not shown, when the second robot 1000B leaves the final goal P1, the third robot 1000C may move to the final goal P1.

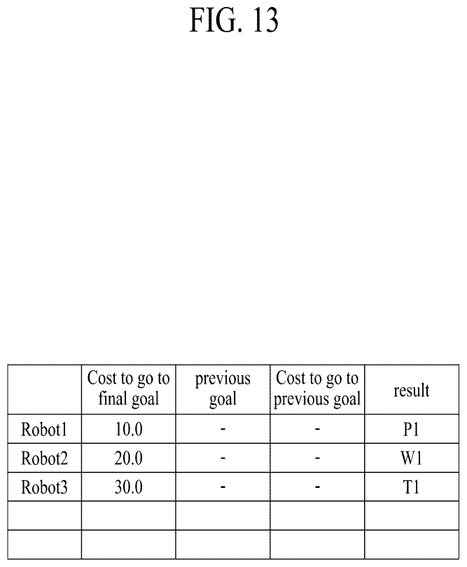

The goal assignment for each robot in FIG. 12 will be further described with reference to FIG. 13. FIG. 13 is a table for robot goal assignment of FIG. 12.

The goal assignment for each robot may be determined based on a cost to go to a final goal from the current location of each robot. The cost to go to a final goal may be determined by at least one of a travel distance and travel time to the final goal along the global path.

As shown in FIG. 13, the cost to go to the first robot 1000A may be the smallest as “10,” the travel cost of the third robot 1000C may be the largest as “30,” and the cost to go to the second robot 1000A may be in the middle as “20.” Based thereon, the control server 3000 may assign the final goal P1, the first intermediate goal W1, and the first temporary goal T1 to the first robot 1000A, the second robot 1000B, and the third robot 1000C, respectively. In the table, the assigned goal is displayed as a calculation result.

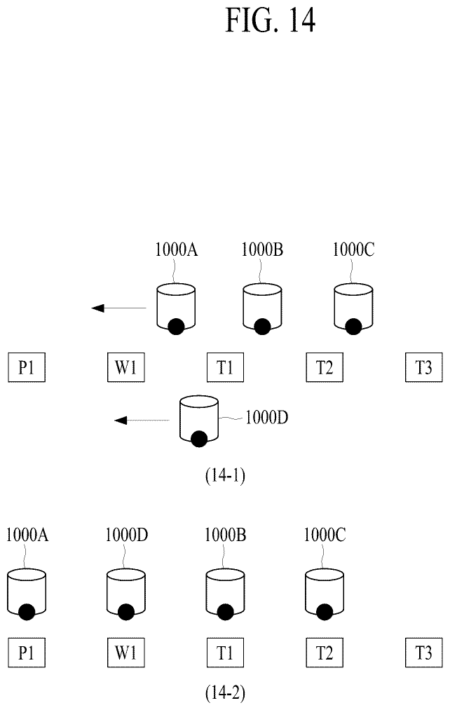

Robot goal assignment will be further described with reference to FIG. 14. FIG. 14 illustrates goal assignment for each robot according to an embodiment of the present disclosure.

While the first robot 1000A, the second robot 1000B, and the third robot 1000C move along the global path established based on the robot goal assignment as described with reference to FIGS. 12 and 13, the FMS 3400 may receive a mission for moving a fourth robot 1000D to the final goal P1 from the mission scheduler 3300 [S51].

As shown in (14-1) of FIG. 14, the fourth robot 1000D may be a robot located further from the final goal P1 than the first robot 1000A and closer to the final goal P1 than the second robot 1000B. When the first robot 1000A, the second robot 1000B, the third robot 1000C, and the fourth robot 1000D have the same or similar driving speeds, the first robot 1000A, the fourth robot 1000D, the second robot 1000B, and the third robot 1000C may sequentially reach the final goal P1.

Then, the FMS 3400 may newly calculate a global path for each of the first robot 1000A, the second robot 1000B, the third robot 1000C, and the fourth robot 1000D. That is, the FMS 3400 may establish a first global path for the first robot 1000A such that the first robot 1000A moves directly to the final goal P1, establish a fourth global path for the fourth robot 1000D such that the fourth robot 1000D moves to the final goal P1 via the first intermediate goal W1, establish a second global path for the second robot 1000B such that the second robot 1000B moves to the final goal P1 via the first temporary goal T1 and the first intermediate goal W1 sequentially, and establish a third global path for the third robot 1000C such that the third robot 1000C moves to the final goal P1 via the second temporary goal T2, the first temporary goal T1, and the first intermediate goal W1 sequentially.

That is, when an arrival goal for the final goal P1 is newly assigned to each of the first robot 1000A, the second robot 1000B, the third robot 1000C, and the fourth robot 1000D, the control server 3000 may newly assign the final goal P1, the first intermediate goal W1, the first temporary goal T1, and the second temporary goal T2 to the first robot 1000A, the fourth robot 1000D, the second robot 1000B, and the third robot 1000C, respectively. The newly calculated first global path, second global path, third global path, and fourth global path may be provided to the first robot 1000A, the second robot 1000B, the third robot 1000C, and the fourth robot 1000D, respectively [S57]. The first global path, the second global path, and the third global path may be updated, and the fourth global path may be newly generated.

Then, as shown in (14-2) of FIG. 14, the first robot 1000A may move to the final goal P1, the fourth robot 1000D may move to the first intermediate goal W1, the second robot 1000B may move to the first temporary goal T1, and the third robot 1000C may move to the second temporary goal T2.

Although not shown, when the first robot 1000A leaves the final goal P1, the fourth robot 1000D may move to the final goal P1, the second robot 1000B may move to the first intermediate goal W1, and the third robot 1000C may move to the first temporary goal T1.

When the fourth robot 1000D leaves the final goal P1, the second robot 1000B may move to the final goal P1, and the third robot 1000C may move to the first intermediate goal W1.

When the second robot 1000B leaves the final goal P1, the third robot 1000c may move to the final goal P1.

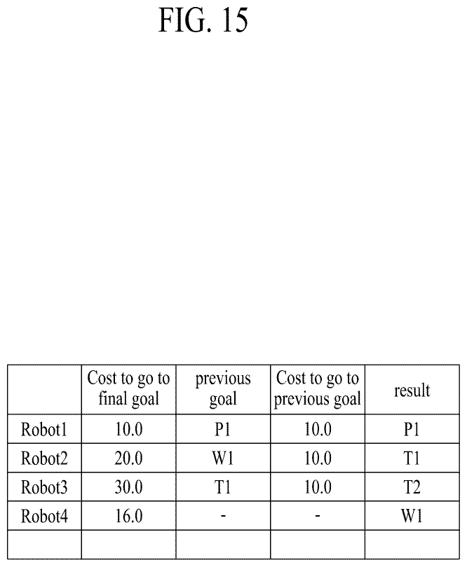

The goal assignment for each robot described with reference to FIG. 14 will be further described with reference to FIG. 15. FIG. 15 is a table for robot goal assignment of FIG. 14.

The goal assignment for each robot may be determined based on a cost to go to a final goal from the current location of each robot. As described above, the cost to go to a final goal may be determined by at least one of a travel distance and travel time to the final goal along the global path.

As shown in FIG. 15, the cost to go to the first robot 1000A may be the smallest as “10”, the cost to go to the fourth robot 1000D may be the second smallest as “16”, the cost to go to the second robot 1000A may be the third smallest as “20”, and the cost to go to the third robot 1000C may be the largest as “30”. Based thereon, the control server 3000 may newly assign the final goal P1, the first intermediate goal W1, the first temporary goal T1, and the second temporary goal T2 to the first robot 1000A, the second robot 1000B, and the third robot 1000C, respectively. In the table, the assigned goal is displayed as a calculation result.

A previous goal means a goal assigned to each of the first robot 1000A, the second robot 1000B, and the third robot 1000C before the global paths are newly calculated, and a cost to go to a previous goal means a cost to go to the previous goal of the first robot 1000A, the second robot 1000B, and the third robot 1000C. Hereinafter, the cost to go to the final goal will be referred to as the “final goal travel cost” or “final goal cost,” and the cost to go to the previous goal will be referred to as the “previous goal travel cost” or “previous goal cost.”

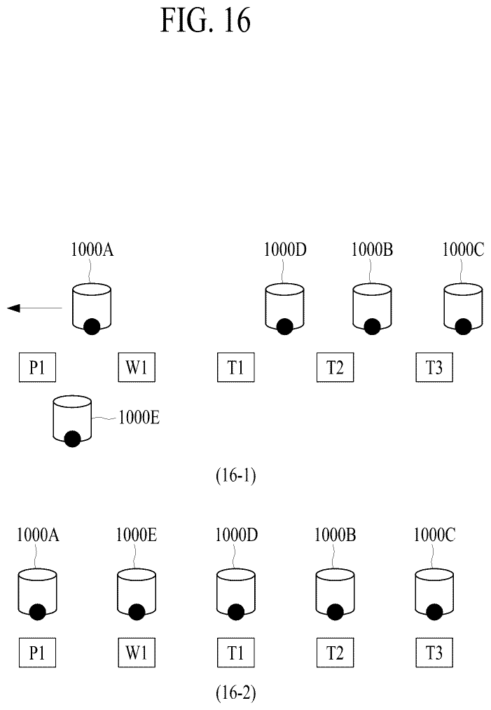

Utilization of the previous goal cost in the robot goal assignment will be further described with reference to FIG. 16. FIG. 16 illustrates goal assignment for each robot according to an embodiment of the present disclosure.

While the first robot 1000A, the fourth robot 1000D, the second robot 1000B, and the third robot 1000C move along the global path established based on the robot goal assignment as described with reference to FIGS. 14 and 15, the FMS 3400 may receive a mission for moving a fifth robot 1000E to the final goal P1 from the mission scheduler 3300 [S51].

Here, as shown in (16-1) of FIG. 16, it is assumed that the first robot 1000A is located at a first distance close to the final goal P1 (for example, the first robot 1000A is located between the first intermediate goal W1 and the final goal P1, and the fifth robot 1000E is located at a second distance closer to the final goal P1. That is, when the first robot 1000A moves a little more and reaches the final goal P1, a mission is generated in which the fifth robot 1000E, which is closer to the final goal P1 than the first robot 1000A, needs to move to the final goal P1. When the first robot 1000A, the second robot 1000B, the third robot 1000C, the fourth robot 1000D, and the fifth robot 1000E have the same or similar driving speeds, the fifth robot 1000E, the first robot 1000A, the fourth robot 1000D, the second robot 1000B, and the third robot 1000C may sequentially reach the final goal P1.

In this situation, when the global path for the robots is re-calculated such that the final goal P1 is assigned to the fifth robot 1000E and the first intermediate goal W1 is assigned to the first robot 1000a, the first robot 1000A may be reversed and move to the first intermediate goal W1. This may be undesirable because it may cause a driving route of the first robot 1000A to become tangled, thereby causing confusion in driving of the robots.

The FMS 3400 may newly calculate a global path for each of the first robot 1000A, the second robot 1000B, the third robot 1000C, the fourth robot 1000D, and the fifth robot 1000E. That is, the FMS 3400 may establish a first global path for the first robot 1000A such that the first robot 1000A moves consecutively to the final goal P1, establish a fifth global path for the fifth robot 1000E such that the fifth robot 1000E moves to the final goal P1 via the first intermediate goal W1, establish a fourth global path for the fourth robot 1000D such that the fourth robot 1000D moves to the final goal P1 via the first temporary goal T1 and the first intermediate goal W1 sequentially, establish a second global path for the second robot 1000B such that the second robot 1000B moves to the final goal P1 via the second temporary goal T2, the first temporary goal T1, and the first intermediate goal W1 sequentially, and establish a third global path for the third robot 1000C such that the third robot 1000C moves to the final goal P1 via the third temporary goal T3, the second temporary goal T2, the first temporary goal T1, and the first intermediate goal W1 sequentially.

That is, when an arrival goal for the final goal P1 is newly assigned to each of the first robot 1000A, the second robot 1000B, the third robot 1000C, the fourth robot 1000D, and the fifth robot 1000E, the control server 3000 may newly assign the final goal P1, the first intermediate goal W1, the first temporary goal T1, the second temporary goal T2, and the second temporary goal T2 to the first robot 1000A, the fifth robot 1000E, the fourth robot 1000D, the second robot 1000B, and the third robot 1000C, respectively. The newly calculated first global path, second global path, third global path, fourth global path, and fifth global path may be provided to the first robot 1000A, the second robot 1000B, the third robot 1000C, the fourth robot 1000D, and the fifth robot 1000E, respectively [S57]. The first global path, the second global path, the third global path, and the fourth global path may be updated, and the fifth global path may be newly generated.

Then, as shown in (16-2) of FIG. 16, the first robot 1000A may move to the final goal P1, the fifth robot 1000E may move to the first intermediate goal W1, the fourth robot 1000E may move to the first temporary goal T1, the second robot 1000B may move to the second temporary goal T2, and the third robot 1000C may move to the third temporary goal T3.

Although not shown, as described above, when the first robot 1000A leaves the final goal P1, the fifth robot 1000E, the fourth robot 1000D, the second robot 1000B, and the third robot 1000C may sequentially move toward the final goal P1.

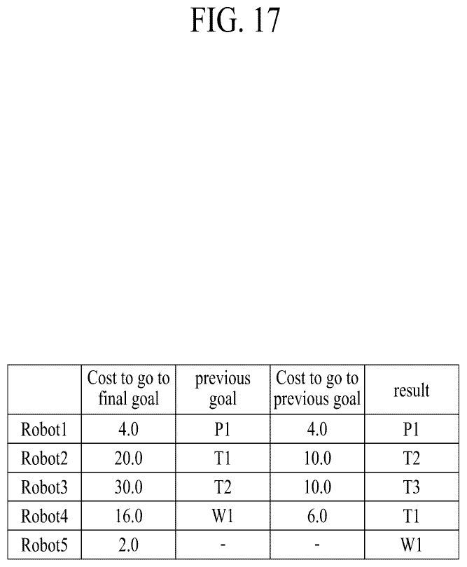

The goal assignment for each robot described with reference to FIG. 16 will be further described with reference to FIG. 17. FIG. 17 is a table for robot goal assignment of FIG. 16.

Goal assignment for each robot may be determined by considering not only the final goal cost of each robot but also the previous goal cost.

As illustrated in FIG. 17, the final goal cost of the fifth robot 1000E may be the smallest as “2”, the final goal cost of the first robot 1000A may be the second smallest as “4”, the final goal cost of the fourth robot 1000D may be the third smallest as “16”, the final goal cost of the second robot 1000B may be the fourth smallest as “20”, and the cost to go to the third robot 1000C may be the largest as “30”.

However, the previous goal cost of the first robot 1000A may be “4” and less than or equal to a predetermined travel cost (e.g. “5”). The predetermined travel cost may be, for example, a travel cost taken when traveling between two neighboring goals from among the final goal P1, the first intermediate goal W1, the first temporary goal T1, the second temporary goal T2, and the third temporary goal T3.

In this case, the control server 3000 may still assign the final goal P1 to the first robot 1000A even though the final goal cost of the first robot 1000A is greater than that of the fifth robot 1000E. The control server 3000 may newly assign the first intermediate goal W1, the first temporary goal T1, the second temporary goal T2, and the third temporary goal T3 to the fifth robot 1000E, the fourth robot 1000D, the second robot 1000B, and the third robot 1000C, respectively. In the table, the assigned goal is displayed as a calculation result.

In the above, it has been explained that the predetermined travel cost is applied for assignment of the final goal P1. However, the predetermined travel cost may also be applied to assignment of other goals, that is, the first intermediate goal W1, the first temporary goal T1, the second temporary goal T2, and the third temporary goal T3.

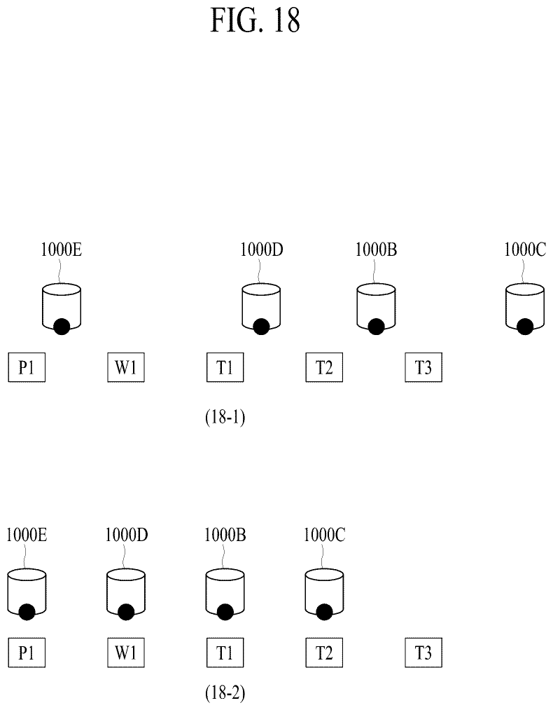

When it takes less than a predetermined travel cost for each robot to reach a previously assigned goal, each robot may pre-occupy the previously assigned goal. However, even if it takes less than a predetermined travel cost for each robot to reach the previously assigned goal, when another goal that is closer to the final goal is available than the previously assigned goal, each robot does not necessarily need to pre-occupy the previously assigned goal. That is, each robot, like the first robot 1000A described with reference to FIGS. 16 and 17, may pre-occupy a previously assigned goal not to move backward when an event occurs that requires the robot to move backward in an opposite direction from the final goal, but may not pre-occupy a previously assigned goal to move forward when an event occurs that requires the robot to move forward in a direction toward the final goal. This will be further described with reference to FIG. 18. FIG. 18 illustrates goal assignment for each robot according to an embodiment of the present disclosure.

While the first robot 1000A, the fifth robot 1000E, the fourth robot 1000D, the second robot 1000B, and the third robot 1000C move along the global path established based on robot goal assignment as described in FIGS. 16 and 17, the first robot 1000A may leave here after arriving at the final goal P1 [S58].

Here, as shown in (18-1) of FIG. 18, the first robot 1000A leaves the final goal P1, and thus it is assumed that the fifth robot 1000E moves toward the final goal P1, and the fourth robot 1000D reaches the first temporary goal T1 when moving a little more. In other words, the fourth robot 1000D may take a predetermined travel cost or less to go to the first temporary goal T.

The FMS 3400 may newly calculate a global path for each of the second robot 1000B, the third robot 1000C, the fourth robot 1000D, and the fifth robot 1000E. That is, the FMS 3400 may establish a fifth global path for the fifth robot 1000E such that the fifth robot 1000E moves to the final goal P1, establish a fourth global path for the fourth robot 1000D such that the fourth robot 1000D moves to the final goal P1 via the first intermediate goal W1 without going through the first temporary goal T1, establish a second global path for the second robot 1000B such that the second robot 1000B moves to the final goal P1 via the first temporary goal T1 and the first intermediate goal W1 sequentially without going through the second temporary goal T2, and establish a third global path for the third robot 1000C such that the third robot 1000C moves the final goal P1 via the second temporary goal T2, the first temporary goal T1, and the first intermediate goal W1 sequentially without going through the third temporary goal T3.

That is, when an arrival goal for the final goal P1 is newly assigned to each of the second robot 1000B, the third robot 1000C, the fourth robot 1000D, and the fifth robot 1000E, the control server 3000 may newly assign the final goal P1, the first intermediate goal W1, the first temporary goal T1, and the second temporary goal T2 to the fifth robot 1000E, the fourth robot 1000D, the second robot 1000B, and the third robot 1000C, respectively. The fourth robot 1000D needs a predetermined travel cost or less to reach the first temporary goal T1, but the first intermediate goal W1 is available, and thus the control server 3000 may assign the first intermediate goal W1 instead of assigning the first temporary goal T1. The newly calculated second global path, third global path, fourth global path, and fourth global path may be provided to the second robot 1000B, the third robot 1000C, the fourth robot 1000D, and the fifth robot 1000E, respectively [S57]. The second global path, the third global path, the fourth global path, and the fifth global path are updated.

Then, as shown in (18-2) of FIG. 18, the fifth robot 1000E may move to the final goal P1, the fourth robot 1000D may move to the first intermediate goal W1, the second robot 1000B may move to the first temporary goal T1, and the third robot 1000C may move to the second temporary goal T2.

Although not shown, as described above, when the fifth robot 1000E leaves the final goal P1, the fourth robot 1000D, the second robot 1000B, and the third robot 1000C may sequentially move toward the final goal P1.

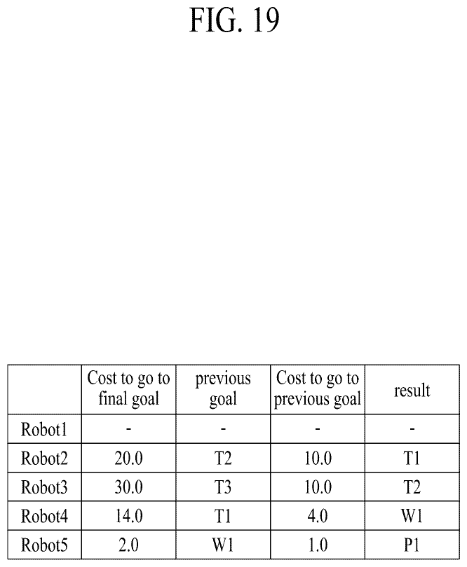

The goal assignment for each robot described with reference to FIG. 18 will be further described with reference to FIG. 19. FIG. 19 is a table for robot goal assignment of FIG. 18.

As shown in FIG. 19, the final goal cost of the fifth robot 1000E may be the smallest as “2”, the final goal cost of the fourth robot 1000D may be the second smallest as “14”, the final goal cost of the second robot 1000B may be the third smallest as “20”, and the cost to go to the third robot 1000C may be the largest as “30”.

However, the previous goal cost of the fourth robot 1000D may be “4” and less than or equal to a predetermined travel cost (e.g. “5”). However, the first intermediate goal W1 is available to the fourth robot 1000D, and thus the fourth robot 1000D does not need to pre-occupy the previously assigned first temporary goal T1.

Accordingly, the control server 3000 may newly assign the final goal P1, the first intermediate goal W1, the first temporary goal T1, and the second temporary goal T2 to the fifth robot 1000E, the fourth robot 1000D, the second robot 1000B, and the third robot 1000C, respectively. In the table, the assigned goal is displayed as a calculation result.

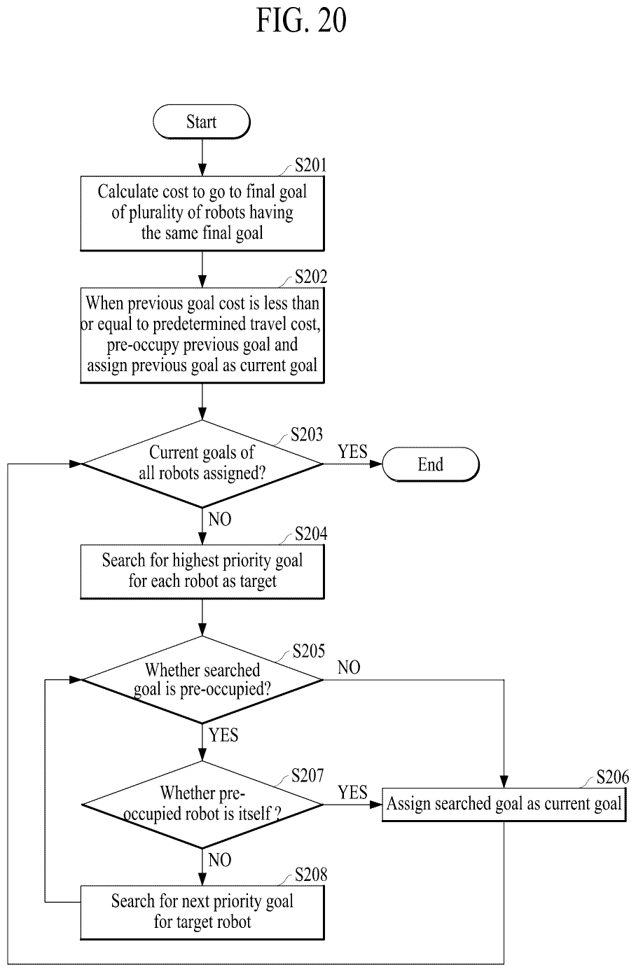

Hereinafter, the goal assignment for each robot described above will be described with reference to FIG. 20. FIG. 20 is a flowchart showing a control server assigning a goal to each robot according to an embodiment of the present disclosure. Hereinafter, for simplicity of description, the final goal, the intermediate goal, and the temporary goals will be collectively referred to as “goal,” and it is assumed that the final goal is the “first priority goal (or highest priority goal),” the first intermediate goal is the “second priority goal,” and the first to Nth temporary goals are the “third priority to (N+2)^{th} priority goals.” The second priority goal and the third to (N+2)^{th} priority coals may also be understood as preliminary goals for the highest priority goal (i.e., the first priority goal).

First, the control server 3000 may calculate a cost to go to a final goal of a plurality of robots having the same final goal [S201].

When the previous goal cost of each robot is less than or equal to a predetermined travel cost, the control server 3000 may pre-occupy the previous goal for each robot and assign the previous goal as the current goal [S202].

The control server 3000 may determine whether the current goals of all robots are assigned [S203].

When the current goals of all robots are assigned, the control server 3000 may terminate the present procedure.

However, when the current goals of all robots are not assigned, the control server 3000 may search for the highest priority goal for each robot in order, starting with the robot with the minimum cost to go to the final goal [S204].

Then, the control server 3000 may determine whether the searched goal is pre-occupied by one of the plurality of robots [S205].

When the searched goal is not occupied, the control server 3000 may assign the searched goal as the current goal for the target robot [S206].

When the searched goal is pre-occupied, the control server 3000 may determine whether the robot that pre-occupies the searched goal is the target robot, i.e. itself [S207].

When the robot that pre-occupies the searched goal is itself, the control server 3000 may assign the searched goal as the current goal for the target robot [S206].

When the robot that pre-occupies the searched goal is not itself, the control server 3000 may search for a next priority goal for the target robot [S208] and then repeat operations S205 to 207.

When the searched goal is assigned as the current goal, the control server 3000 may repeat operations S203 to S208 until the current goals of all robots are assigned.

The process according to FIG. 20 may be performed, for example, when an event of operation S51 or operation S58 of FIG. 5 occurs.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A robot movement control method comprising:
calculating a cost to go to a final goal of each of plurality of robots having the same final goal; and
based on that the plurality of robots have no cost to a previous goal or a cost to a previous goal exceeding a predetermined travel cost, assigning, in order from a robot having a smallest cost to a final goal from among the plurality of robots, the final goal and at least one next priority goal for the final goal as a current goal in order from a highest goal.

2. The robot movement control method of claim 1, further comprising:
based on that at least one of the plurality of robots has a previous goal cost less than or equal to the predetermined travel cost, pre-occupying a corresponding previous goal and assigning the previous goal to the at least one robot as the current goal; and
assigning, to remaining robots from among the plurality of robots, in order from a robot with a smallest cost to a final goal, at least one unoccupied goal from among the final goal and the next priority goal as the current goal in order from a highest priority goal.

3. The robot movement control method of claim 2, further comprising:
generating a global path passing through a corresponding current goal for each robot of the plurality of robots; and
providing the generated global path to each robot.

4. The robot movement control method of claim 1, wherein the final goal and the at least one next priority goal are pre-designated goals.

5. The robot movement control method of claim 4, wherein, based on that a first robot is located in the final goal, the next priority goal is a goal for a second robot to wait until a first robot leaves the final goal.

6. The robot movement control method of claim 5, wherein, even if the second robot waits at the next priority goal, a location of the next priority goal is determined to minimize movement impediment of a first robot or a third robot.

7. The robot movement control method of claim 1, wherein the next priority goal includes a waiting goal for the final goal and at least one temporary goal for the waiting goal.

8. The robot movement control method of claim 3, wherein the global path is to be generated to further pass through at least one of a pass-through goal or a traffic goal.

9. The robot movement control method of claim 2, wherein assignment of the current goal is performed based on that a mission scheduled to move toward the final goal is assigned to one robot.

10. The robot movement control method of claim of claim 2, wherein assignment of the current goal is performed based on that one robot of the plurality of robots leaves the final goal.

11. A control server for controlling movement of a robot, the control server comprising:
a warehouse management system (WMS) configured to manage at least one item and an order for a location of the item;
a material control system (MCS) configured to configure at least one order as a mission;
a mission scheduler configured to schedule a route for the mission; and
a fleet management system (FMS) configured to generate a global path of a robot for the route-scheduled mission, wherein the FMS is configured to calculate the cost to a final goal of each of a plurality of robots having the same final goal, and based on that the plurality of robots have no cost to a previous goal or a cost to a previous goal exceeding a predetermined travel cost, assign, in order from a robot having a smallest cost to a final goal from among the plurality of robots, the final goal and at least one next priority goal for the final goal as a current goal in order from a highest goal.

12. The control server of claim 11, wherein the FMS is configured to,
based on that at least one of the plurality of robots has a previous goal cost less than or equal to the predetermined travel cost, pre-occupy a corresponding previous goal and assign the previous goal to the at least one robot as the current goal, and assign, to remaining robots from among the plurality of robots, in order from a robot with a smallest cost to a final goal, at least one unoccupied goal from among the final goal and the next priority goal as the current goal in order from a highest priority goal.

13. The control server of claim 12, wherein the FMS is configured to generate a global path passing through a corresponding current goal for each robot of the plurality of robots, and provide the generated global path to each robot.

14. The control server of claim 11, wherein the final goal and the at least one next priority goal are pre-designated goals.

15. The control server of claim 14, wherein, based on that a first robot is located in the final goal, the next priority goal is a goal for a second robot to wait until a first robot leaves the final goal.

16. The control server of claim 15, wherein, even if the second robot waits at the next priority goal, a location of the next priority goal is determined to minimize movement impediment of a first robot or a third robot.

17. The control server of claim 11, wherein the next priority goal includes a waiting goal for the final goal and at least one temporary goal for the waiting goal.

18. The control server of claim 13, wherein the FMS is configured to
generate the global path to further pass through at least one of a pass-through goal or a traffic goal.

19. The control server of claim 12, wherein the FMS is configured to, based on receiving of the route-scheduled mission from the mission scheduler, perform assignment of the current goal.

20. The control server of claim 12, wherein the FMS is configured to,
based on that one of the plurality of robots leaves the final goal, assignment of the current goal is performed.
